(19) United States
(12) Patent Application Publication
(10) Pub. No.: US 2015/0249244 A1
(43) Pub. Date: Sep. 3, 2015

(54) ALKALI METAL-CHALCOGEN BATTERY HAVING LOW SELF-DISCHARGE AND HIGH CYCLE LIFE AND PERFORMANCE

(71) Applicants: FRAUNHOFER-GESELLSCHAFT ZUR FÖRDERUNG DER ANGEWANDTEN FORSCHUNG E.V., Munich (DE); TECHNISCHE UNIVERSITÄT DRESEN, Dresden (DE)

(72) Inventors: Sören Thieme, Dresden (DE); Jan Brückner, Dresden (DE); Ingolf Bauer, Radebeul (DE); Holger Althues, Dresden (DE); Stefan Kaskel, Dresden (DE)

(21) Appl. No.: 14/428,340

(22) PCT Filed: Sep. 13, 2013
(86) PCT No.: PCT/EP2013/068979

§ 371 Date: Mar. 13, 2015

(30) Foreign Application Priority Data
Sep. 14, 2012 (DE) 10 2012 018 621.5

(51) Int. Cl. H01M 2/16; H01M 10/0567; H01M 4/62; H01M 10/052; H01M 4/136; H01M 4/58

(52) U.S. Cl. CPC H01M 2/1673; H01M 4/136; H01M 4/5815; H01M 4/625; H01M 10/052; H01M 10/0567; H01M 2/1653; H01M 4/622

(57) ABSTRACT

An alkali-chalcogen battery that includes a cathode that includes at least one of at least one chalcogen and at least one alkali-chalcogen compound, and an anode. At least one of an alkali metal-containing liquid electrolyte, gel electrolyte and solid electrolyte is disposed between the anode and the cathode. Also, a cation-selective separator is disposed at least in regions between the anode and the cathode, the separator being permeable for alkali metal ions and impermeable for polychalcogenide ions (Zn²⁻ with n≧2, Z representing the chalcogen), and the separator having a maximum layer thickness of 30 μm.

### CROSS-REFERENCE TO RELATED APPLICATIONS

This application is a national phase application of PCT Application No. PCT/EP2013/068979, internationally filed Sep. 13, 2013, which claims priority to German Application No. 10 2012 018 621.5, filed Sep. 14, 2012, both of which are herein incorporated by reference in their entirety.

### TECHNICAL FIELD

This disclosure relates to an alkali-chalcogen battery and, in particular, to a lithium-sulphur battery which has a high capacity and cycle stability and reduced automatic discharge.

### BACKGROUND

In lithium-sulphur batteries, the result is formation of so-called lithium polysulphides (Li₂Sₙ, 2≦n≦8). Some of these polysulphide species are soluble in the commonly used electrolytes (e.g. a mixture of DME:DOL with a conductive salt). The dissolved polysulphides are reduced to lower polysulphide species on the anode.

During the charging process, a reoxidation on the cathode follows the reduction, as a result of which a circulation process is produced and significantly reduces the Coulomb efficiency of the accumulator (Jayaprakash, N. et al., Ang. Chem. Int. Ed., 50: 5904-5908, 2011). If the battery is stored in the charged state, likewise the result can be formation of soluble polysulphides which are reduced on the anode. As a result, the capacity of the cell is reduced. Furthermore, the cycle stability is reduced by the irreversible processes associated with these procedures.

The addition of N—O-containing compounds (such as e.g. LiNO₃) leads to a substantially improved Coulomb efficiency and cycle stability (U.S. Pat. No. 7,354,680; Aurbach, D. et al., J. Electrochem. Soc., 156: A694-A702, 2009).

The mechanism begins on the lithium anode. It is assumed that, by means of the nitrate compounds, the result is formation of sulphite species on the surface of the lithium anode. The addition of LiNO₃ or other N—O-containing compounds does not however solve the problem entirely for the following reasons:
The degradation of the anode is not completely prevented, which negatively influences the cycle stability of the cell;
The addition of LiNO₃ has an influence on the cell chemistry and possibly leads to unknown or undesired subsidiary reactions; and
LiNO₃ increases the weight of the electrolyte.

Polyethylene oxide-based polymer electrolytes have been tested successfully already as cathode additive or as a membrane in Li-sulphur batteries (Scrosati, F. et al., J. Power Sources, 161: 560-564, 2006; Nazar, L. et al., J. Mat. Chem., 20: 9821-9826, 2010).

The use of an anionic polymer as cathode component for improving the cycle stability of Li-sulphur cells is described in the patent literature (US 2012/088154). Since the graphene-sulphur nanocomposites of the cathode hereby have a very large surface area, relatively large quantities of Nafion® are necessary in order to coat or wet the entire graphene-sulphur nanocomposite with Nafion®. Since Nafion® is a poorly conducting component, the maximum power output of the Li—S battery is significantly reduced by the high Nafion® proportion of the cathode.

### SUMMARY

The present disclosure provides an alkali-chalcogen battery which can provide no automatic discharge and high cycle stability.

Relative to the state of the art, the battery has improved power values. This is achieved by an ion-selective separator between cathode and anode, which separator is permeable for alkali metal ions but impermeable for polychalcogenide ions, such as e.g. polysulphide ions. Hence, on the one hand, the migration of polysulphide ions from the cathode to the anode is blocked and consequently the formation of dendritic structures on the anode is prevented. As a result, automatic discharge of Li—S batteries is effectively prevented and a high capacity and cycle stability is achieved. Also, the ion-selective separator can have an extremely thin configuration so that, as a result, a significant increase in power can be achieved.

The subject according to the disclosure is intended to be explained in more detail with reference to the subsequent Figures and examples without wishing to restrict the subject to the specific embodiments illustrated here.

### BRIEF DESCRIPTION OF THE DRAWINGS

FIG. 1 is a diagram illustrating a mode of operation of a Li—S battery, according to embodiments described in the disclosure.

FIG. 2 is a diagram illustrating the result of the measurement of the terminal voltage of an Li—S battery, according to embodiments described in the disclosure.

FIG. 3 is a diagram illustrating the cation-selective separator, according to embodiments described in the disclosure.

### DETAILED DESCRIPTION

The solution path represents—with a minimal surface area of the separator—an impermeable barrier for polysulphides and can hence prevent extensively direct contact of polysulphides with the lithium anode.

The anionic polymer Nafion® is known from other applications, such as fuel cells or chlorine-alkali electrolysis as a cation-selective membrane. On the basis of this property of Nafion®, the disclosure describes use of a separator comprising or consisting of an anionic, cation-selective polymer (such as e.g. Nafion®) as separator in a Li—S battery.

According to the disclosure, an alkali-chalcogen battery, in particular a Li—S battery, is hence provided, which comprises
a) a cathode comprising at least one chalcogen, e.g. sulphur and/or at least one alkali-chalcogen compound, such as e.g. a lithium- or sodium-sulphur species;
b) an anode; and
c) an alkali metal-containing, e.g. lithium- or sodium-containing, liquid electrolyte, gel electrolyte and/or solid electrolyte disposed between the anode and the cathode.

The battery is characterised in that a cation-selective separator is disposed between anode and cathode, which separator is permeable for alkali metal cations, in particular lithium- or sodium ions and impermeable for polychalcogenide ions (Zₙ²⁻ with n≧2, Z representing the chalcogen, e.g. sulphur). The cation-selective separator is thereby at most 30 μm thick.

It has been observed that, with the battery according to the disclosure, the polysulphide shuttle mechanism observed for example in the case of Li—S batteries from the state of the art can be suppressed.

Suppressing the polysulphide diffusion to the (lithium-) anode prevents potentially irreversible decomposition processes on the anode and consequently leads to improved cycle stability. Furthermore, automatic discharge of lithium-sulphur cells, in contrast to the addition of LiNO₃, can be prevented over longer periods of time (>60 days) and hence the entire capacity of the Li—S battery is maintained over a longer period of time.

The crucial advantage of an extremely thin cation-selective separator has the effect that the ion conductivity between the anode and/or cathode is not reduced by a large thickness of a poorly conducting, cation-selective membrane—applied on the anode and/or cathode. Consequently, high discharge currents are possible and the Li—S battery can provide high power values.

In some embodiments, the separator separates the electrolyte completely spatially into an anode-side part of the electrolyte and a cathode-side part of the electrolyte, both parts of the electrolyte being contacted only via the separator.

In some embodiments of the Li—S battery, the cation-selective separator between anode and cathode is characterised in that it comprises an anionic polymer, in some embodiments an anionic tetrafluoroethylene-perfluoro copolymer, and in some embodiments a sulphonic acid group-containing tetrafluoroethylene-perfluoro copolymer, in particular a tetrafluoroethylene/perfluoro(4-methyl-3,6-dioxa-7-octane-1-sulphonic acid) copolymer (Nafion®, CAS-No.: 31175-20-9), or consists thereof. It has been shown that such separators, despite the small layer thickness, have extremely high chemical stability which contributes to the long-term stability of the battery.

In some embodiments, the cation-selective separator between anode and cathode can have a layer thickness of 50 nm to 25 μm, in some embodiments 100 nm to 10 μm, and in some embodiments 200 nm to 5 μm.

In some embodiments, the cation-selective separator can have a planar configuration, and, in some embodiments, the cation-selective separator can be a planar membrane.

The battery itself can thereby likewise have a planar construction but can also be present as a coiled battery.

In some embodiments, the cation-selective separator between anode and cathode comprises a porous, planar substrate which has pores with an average pore diameter d₅₀ of 1 nm to 5 μm. In some embodiments, the pores have an average pore diameter d₅₀ of 5 nm to 500 nm. In some embodiments, the pores have an average pore diameter d₅₀ of 10 nm to 200 nm. In some embodiments, the pores have an average pore diameter d₅₀ of 20 to 100 nm.

The pores of the substrate are hereby impregnated partially or completely with an anionic polymer. In some embodiments, the pores are impregnated partially or completely with an anionic tetrafluoroethylene-perfluoro copolymer. In some embodiments, the pores are impregnated partially or completely with a sulphonic acid group-containing tetrafluoroethylene-perfluoro copolymer, in particular with a tetrafluoroethylene/perfluoro (4-methyl-3,6-dioxa-7-octane-1-sulphonic acid) copolymer (Nafion®, CAS No.: 31175-20-9).

In some embodiments, the substrate comprises a porous thermoplastic material, in some embodiments a polyolefin, in some embodiments at least one of a polypropylene, a polyethylene, a polyethylene terephthalate, and also composite materials hereof, or consists thereof. In particular, Celgard® 2500 is possible in this respect, a porous PP film with a thickness of 25 μm and an average pore diameter of 0.064 μm. The average degree of porosity of these substrate materials can be between 30 and 70%, e.g. 55%.

In some embodiments of the battery, the cathode can comprise an electrically conductive carbon material.

A cathode, as can be contained in the Li—S battery according to the invention, is known for example from DE 10 2012 203 019.0. With respect to possible embodiments of the cathode and also possible production methods, reference is made to this patent application, the disclosure content of which is made in this respect also the subject of the present application.

Furthermore, it is possible that the cathode, relative to the total weight of the cathode, comprises
a) in some embodiments 40-90% by weight, in some embodiments 50-80% by weight, and in some embodiments 60-75% by weight of sulphur;
b) in some embodiments 1-55% by weight, in some embodiments 5-35% by weight, and in some embodiments 10-25% by weight, of electrically conductive carbon material; and/or
c) in some embodiments 2-50% by weight, in some embodiments 3-20% by weight, and in some embodiments 5-10% by weight, of plastic material.

The cathode can comprise in addition
a) sulphur, electrically contacted sulphur and/or a lithium- or sodium-sulphur species, in particular Li₂S;
b) as electrically conductive carbon material, porous carbon, carbon black, graphene, graphite, diamond-like carbon (DLC), graphite-like carbon (GLC), carbon fibres, carbon nanotubes and/or carbon hollow balls, and/or
c) plastic material, preferably fibrillar plastic material, particularly preferred fibrillar polytetrafluoroethylene.

In some embodiments,
a) the carbon nanotubes have a diameter of 0.1 to 100 nm, in some embodiments 1 to 50 nm, and in some embodiments 5 to 25 nm; and/or
b) in some embodiments the carbon fibres have a diameter of 1 to 100 μm, in some embodiments 5 to 50 μm, and in some embodiments 10 to 20 μm.

In some embodiments of the Li—S battery according to the disclosure, the cathode can be configured as a film with a thickness of 20-1,000 μm, in some embodiments with a thickness of 50-500 μm, and in some embodiments with a thickness of 80-300 μm. Optionally, it is applied on an electrically conductive substrate, such as on a metal and/or carbon material.

In some embodiments, the electrochemically active cathode material is applied at least in regions on the surface of the electrically conductive carbon material or the electrically conductive carbon material is applied on the surface of the active cathode material.

The anode can comprise an alkali metal, such as e.g. Li or Na, or be formed herefrom. In addition, the anodes can comprise Si or Sn or alloys hereof or be formed therefrom. It is likewise possible that the anode comprises a conductive substrate.

The conductive substrate of the anode can comprise a material selected from the group consisting of lithium, carbon, graphite, graphene, diamond-like carbon (DLC), graphite-like carbon (GLC), carbon black and carbon nanotubes or consist thereof.

Furthermore, the anode can comprise silicon and/or tin in a total quantity, relative to the total mass of the anode, in some embodiments, of 0.1 to 90% by weight, in some embodiments 20 to 80% by weight, and in some embodiments 40 to 70% by weight.

In some embodiments, the conducting substrate of the anode is coated with silicon and/or tin or lithiated with an alkali metal, e.g. with Na or with lithium, in some embodiments lithium metal, and in some embodiments lithium metal foil. In some embodiments, the coating being a conformal coating, in some embodiments a PVD- and/or CVD coating, and in some embodiments a PE-CVD coating.

The electrolyte of the Li—S battery according to the disclosure can be selected from the group consisting of solutions or suspensions of at least one lithium salt in at least one cyclic or non-cyclic ether, polyether and/or sulphone, preferably solutions of
a) lithium-bis(trifluoromethanesulphonyl)imide (LiTFSI);
b) lithium trifluoromethanesulphonate;
c) lithium nitrate; and/or
d) at least one lithium salt and at least one N—O-containing additive;
   in at least one cyclic or non-cyclic ether, polyether and/or sulphone, in particular in dimethoxyethane (DME), tetraethylglycol dimethyl ether (TEGDME) and/or 1,3-dioxolane (DOL).

According to the disclosure, an anionic polymer can be used, in some embodiments an anionic tetrafluoroethylene-perfluoro copolymer, and in some embodiments a sulphonic acid group-containing tetrafluoroethylene-perfluoro copolymer, in particular a tetrafluoroethylene/perfluoro (4-methyl-3,6-dioxa-7-octane-1-sulphonic acid) copolymer (Nafion®, CAS No.: 31175-20-9) as impregnation for separators in lithium-sulphur batteries.

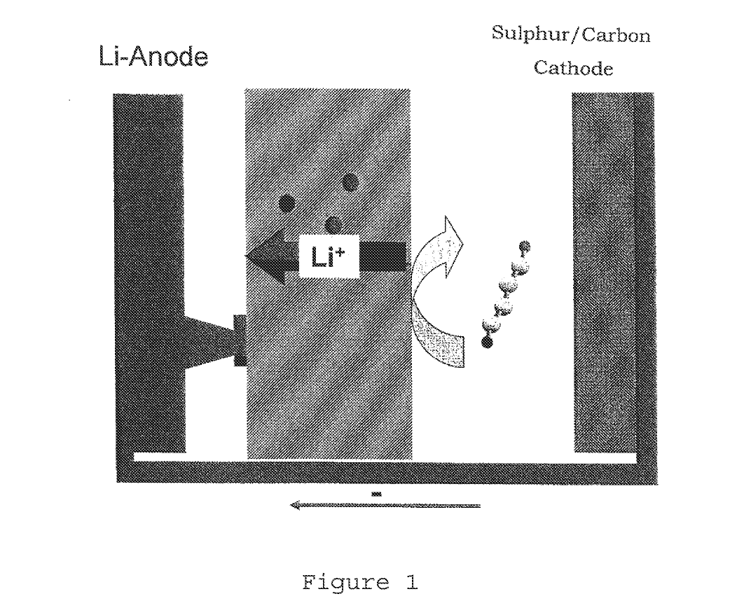

FIG. 1 is a diagram illustrating a mode of operation of a Li—S battery, according to embodiments described in the disclosure, which has a cation-selective separator disposed between anode and cathode, which separator is permeable for lithium ions and impermeable for polysulphide ions. The separator as barrier has the effect that the polysulphides cannot react on the anode. As a result, losses in the efficiency and degradation mechanisms are restricted. Furthermore, the separator acts here also as mechanical barrier which prevents the growth of dendrites.

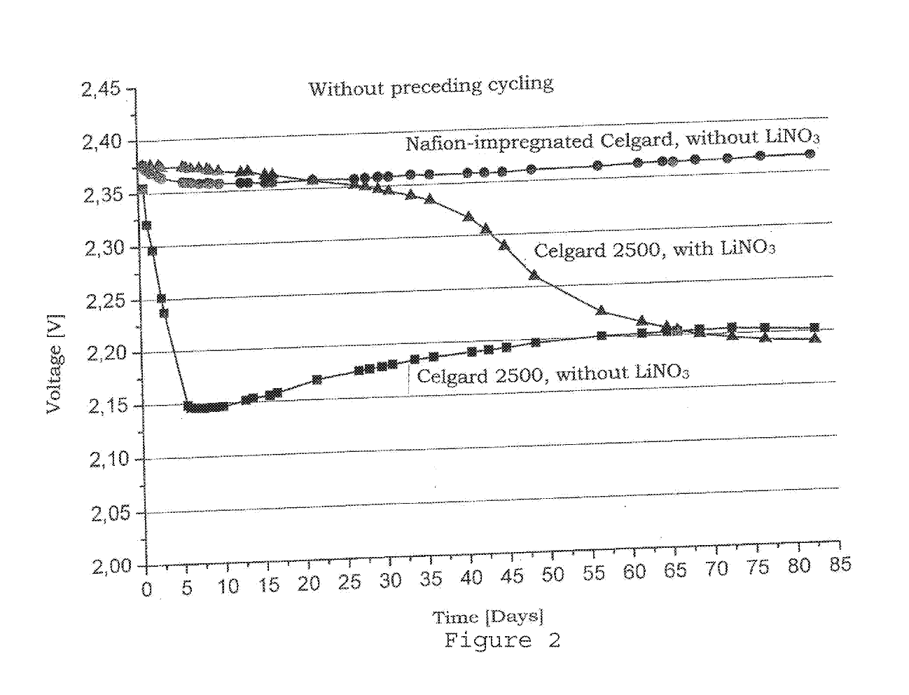

FIG. 2 is a diagram illustrating the result of the measurement of the terminal voltage of an Li—S battery, according to the disclosure, (“Nafion-impregnated Celgard 2500”) compared with two Li—S batteries (“Celgard 2500 with LiNO₃” and “Celgard 2500 without LiNO₃”) which serve as reference thereto. The Li—S battery according to the disclosure (“Nafion-impregnated Celgard 2500”) hereby has a separator made of Celgard 2500 which was impregnated with Nafion® by the mode of operation indicated under “example 2”. Because of the Nafion® impregnation, the electrolyte additive LiNO₃, known from the state of the art, for improving the electrochemical properties could be dispensed with. In the case of the other Li—S batteries (“Celgard 2500 with LiNO₃” and “Celgard 2500 without LiNO₃”), the separator Celgard 2500®, known in the literature and technology, was used without more extensive treatment. A battery (“Celgard 2500 with LiNO₃”) comprised 0.25 mol/1 LiNO₃ as electrolyte additive for improving the electrochemical properties. The electrolyte of a further battery (“Celgard 2500 without LiNO₃”) was not mixed with LiNO₃ and served as comparative battery. In contrast to the batteries from the state of the art, the Li—S battery according to the disclosure has no loss of terminal voltage even after 85 days, i.e. no automatic discharge of the battery occurs.

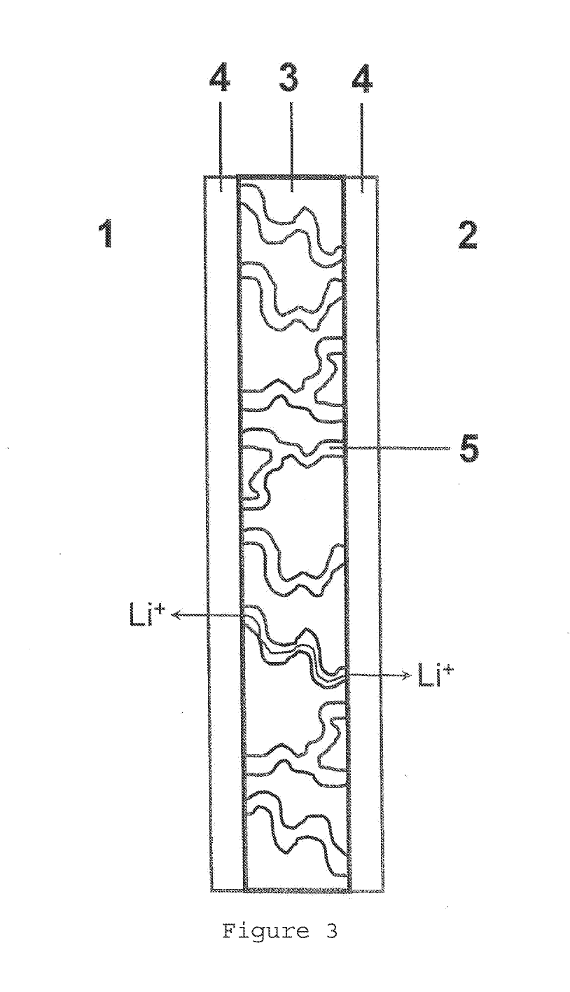

FIG. 3 is a diagram illustrating the cation-selective separator, according to embodiments described in the disclosure. FIG. 3 shows the arrangement of the separator between the anode 1 and the cathode 2. The pores 5 of the porous polymer membrane 3 are hereby filled partially or completely with a sulphonic acid group-containing tetrafluoroethylene-perfluoro copolymer. Optionally, a coating made of a sulphonic acid group-containing tetrafluoroethylene-perfluoro copolymer 4 is situated on one or both sides of the porous polymer membrane.

### Example 1

### Nafion® Membrane as Separator

A Nafion® membrane NR211 (25 μm thickness) is used as separator in an electrochemical cell. Processing of the membrane can be effected analogously to the processing of conventional porous polymer membranes.

If necessary, the Nafion® membrane can be placed in an electrolyte solution over a few hours before the membrane saturated with electrolyte is used as separator membrane in an electrochemical Li—S cell.

### Example 2

### Porous Substrate Impregnated with Nafion® as Separator

According to the following example, a porous substrate can be impregnated with an anionic polymer:
1. 20% by weight of Nafion® solution is concentrated for a few hours at 80° C. in a circulating air drying cabinet;
2. From the residue by addition of ethanol, a 10% by weight Nafion® solution is produced.
3. The porous substrate Celgard® 2500 is placed in the above-mentioned Nafion® solution for 1 h;
4. Drying of the substrate at 55° C. for 1 h in the circulating air drying cabinet.

The porous substrate impregnated according to this method (Celgard® 2500 impregnated with Nafion®) can be used as separator in an Li—S battery.

1.-14. (canceled)

15. An alkali-chalcogen battery comprising:
a cathode including at least one of at least one chalcogen and at least one alkali-chalcogen compound;
an anode; and
at least one of an alkali metal-containing liquid electrolyte, gel electrolyte and solid electrolyte disposed between the anode and the cathode, wherein a cation-selective separator is disposed at least in regions between the anode and the cathode, the separator being permeable for alkali metal ions and impermeable for polychalcogenide ions (Zₙ²⁻ with n≧2, Z representing the chalcogen), the separator having a maximum layer thickness of 30 μm.

16. The battery according to claim 15, wherein the separator separates the electrolyte completely spatially into an anode-side part of the electrolyte and a cathode-side part of the electrolyte, both parts of the electrolyte being contacted only via the separator.

17. The battery according to claim 15, wherein the cation-selective separator between the anode and the cathode comprises at least one of an anionic polymer, an anionic tetrafluoroethylene-perfluoro copolymer, and a sulphonic acid group-containing tetrafluoroethylene-perfluoro copolymer, in particular a tetrafluoroethylene/perfluoro(4-methyl-3,6-dioxa-7-octane-1-sulphonic acid) copolymer (Nafion®, CAS No.: 31175-20-9).

18. The battery according to claim 15, wherein the cation-selective separator between the anode and the cathode has at least one of a layer thickness of 50 nm to 25 μm, a layer thickness of 100 nm to 10 μm, and a layer thickness of 200 nm to 5 μm.

19. The battery according to claim 15, wherein the cation-selective separator has at least one of a planar configuration and a planar membrane.

20. The battery according to claim 15, wherein the cation-selective separator between the anode and the cathode comprises a porous, planar substrate which has pores with an average pore diameter d₅₀ of at least on of the ranges of 1 nm to 5 μm, 5 nm to 500 nm, 10 nm to 200 nm, and 20 to 100 nm, the pores of the substrate being hereby at least partially impregnated with at least one of an anionic polymer, an anionic tetrafluoroethylene-perfluoro copolymer, a sulphonic acid group-containing tetrafluoroethylene-perfluoro copolymer, and a tetrafluoroethylene/perfluoro(4-methyl-3,6-dioxa-7-octane-1-sulphonic acid) copolymer (Nafion®, CAS No.: 31175-20-9).

21. The battery according to claim 20, wherein the substrate comprises at least one of a porous thermoplastic material, a polyolefin, a polypropylene, a polyethylene, a polyethylene terephthalate, and composite materials thereof.

22. The battery according to claim 15, wherein the cathode, relative to the total weight of the cathode, comprises at least one of:
at least one of 40-90% by weight, 50-80% by weight, and 60-75% by weight, of electrochemically active cathode material;
at least one of 1-55% by weight, 5-35% by weight, and 10-25% by weight, of electrically conductive carbon material; and
at least one of 0.5-30% by weight, 1-10% by weight, and 2-5% by weight, of plastic material.

23. The battery according to claim 15, wherein the cathode comprises at least one of:
an electrochemically active cathode material comprising at least one of sulphur, a lithium-sulphur compound, and Li₂S;
at least one of an electrically conductive carbon material, a porous carbon, a carbon black, a graphene, a graphite, a diamond-like carbon DLC), a graphite-like carbon (GLC), carbon fibres, carbon nanotubes, and carbon hollow balls; and
at least one of fibrillar plastic material and fibrillar polytetrafluoroethylene.

24. The battery according to claim 23, wherein at least one of:
the carbon nanotubes have a diameter in at least one of the ranges of 0.1 to 100 nm, 1 to 50 nm, and 5 to 25 nm; and
the carbon fibres have a diameter in at least one of the ranges of 1 to 100 μm, 5 to 50 μm, and 10 to 20 μm.

25. The battery according to claim 15, wherein the cathode is configured as a film having a thickness in at least one of the ranges of 20-1,000 μm, 5-500 μm, and 80-300 μm and applied on at least one of an electrically conductive substrate, a metal and carbon material.

26. The battery according to claim 15, wherein the electrochemically active cathode material is applied at least in regions on the surface of the electrically conductive carbon material or the electrically conductive carbon material is applied on the surface of the active cathode material.

27. The battery according to claim 15, wherein the electrolyte is selected from the group consisting of solutions or suspensions of at least one lithium salt in at least one of, a cyclic ether, a non-cyclic ether, a polyether, a sulphone, and solutions of at least one of:
lithium-bis(trifluoromethanesulphonyl)imide (LiTFSI);
lithium trifluoromethanesulphonate;
lithium nitrate; and
at least one lithium salt and at least one N—O-containing additive,
in at least one of a cyclic ether, a non-cyclic ether, a polyether, a sulphone, dimethoxyethane (DME), tetraethyleneglycol dimethyl ether (=TEGDME), and 1,3-dioxolane (DOL).

28. The battery according to claim 15, comprising use of at least one of an anionic polymer, an anionic tetrafluoroethylene-perfluoro copolymer, a sulphonic acid group-containing tetrafluoroethylene-perfluoro copolymer, and a tetrafluoroethylene/perfluoro(4-methyl-3,6-dioxa-7-octane-1-sulphonic acid) copolymer (Nafion®, CAS No.: 31175-20-9) as impregnation for the separator.
